(19) United States
(12) Patent Application Publication
(10) Pub. No.: US 2014/0072388 A1
(43) Pub. Date: Mar. 13, 2014

(54) SHEET POST-PROCESSING APPARATUS, IMAGE FORMING SYSTEM, AND SHEET BINDING METHOD

(71) Applicants: Takashi HASHIMOTO, Kanagawa (JP); Koichi KUDO, Kanagawa (JP); Tetsuo WATANABE, Kanagawa (JP); Yoshinobu TAKEYAMA, Kanagawa (JP); Fumihito MASUBUCHI, Kanagawa (JP); Natsumi MATSUE, Kanagawa (JP); Takeshi OGAWA, Kanagawa (JP)

(72) Inventors: Takashi HASHIMOTO, Kanagawa (JP); Koichi KUDO, Kanagawa (JP); Tetsuo WATANABE, Kanagawa (JP); Yoshinobu TAKEYAMA, Kanagawa (JP); Fumihito MASUBUCHI, Kanagawa (JP); Natsumi MATSUE, Kanagawa (JP); Takeshi OGAWA, Kanagawa (JP)

(73) Assignee: RICOH COMPANY, LIMITED, Tokyo (JP)

(21) Appl. No.: 14/020,921

(22) Filed: Sep. 9, 2013

(30) Foreign Application Priority Data
Sep. 7, 2012 (JP) 2012-197663
Nov. 7, 2012 (JP) 2012-245472

(51) Int. Cl. B42C 5/00

(52) U.S. Cl. CPC B42C 5/00
USPC 412/1; 412/33

(57) ABSTRACT

A sheet post-processing apparatus includes: a binding unit that binds, as a bundle, a plurality of sheets by heating and pressing binding margin portions of the sheets set in advance, using toner interposed between the sheets as an adhesive material; and a pre-heating unit that heats the binding margin portions of the sheets while the sheets are stacked.

### CROSS-REFERENCE TO RELATED APPLICATIONS

The present application claims priority to and incorporates by reference the entire contents of Japanese Patent Application No. 2012-197663 filed in Japan on Sep. 7, 2012, and Japanese Patent Application No. 2012-245472 filed in Japan on Nov. 7, 2012.

### BACKGROUND OF THE INVENTION

1. Field of the Invention

The present invention relates to a sheet post-processing apparatus for binding multiple sheets as a bundle using toner as an adhesive material, an image forming system having the sheet post-processing apparatus and an image forming apparatus such as an MFP including at least one of a copying machine, a printer, a facsimile, and a plotter, and also relates to a sheet binding method.

2. Description of the Related Art

In binding processing performed by a sheet post-processing apparatus serving as a sheet post-processing apparatus, a method for binding sheets with steel staples with a stapler is generally used, but when a used sheet bundle is recycled, it is necessary to remove the steel staples, which makes the process troublesome.

In order to solve this problem, in recent years, a toner staple method for binding sheets using toner as an adhesive material has been suggested.

In an image forming apparatus such as a copying machine, an electrostatic latent image is formed on an image carrier on the basis of image data, and the electrostatic latent image is visualized as a toner image by a developing unit, and after the toner image is ultimately transferred onto a recording medium, the recording medium is passed through a fixing unit to fix the toner image thereon.

When binding processing is done using toner as an adhesive material, the toner is attached to a binding margin portion in addition to the original image during image formation, and the entire sheet is fixed with the fixing unit.

In the sheet post-processing apparatus, the fixed sheets are stacked in a tray, and binding margin portion is pressurized and heated in a thickness direction of the bundle while a desired number of sheets are made into the bundle, so that the toner in the binding margin portion is melted again to be adhered.

However, in the method for heating and pressurizing the binding margin portion of the stacked sheet bundle upon sandwiching the binding margin portion at a time, there are air layers between sheets, and in order to uniformly heat ne entire thickness direction of the bundle, there is a problem in that a high temperature and a high pressure are required and it takes a lot of time.

Japanese Laid-open Patent Publication No. 2000-255881 suggests a method for heating and pressuring a portion corresponding to the binding margin portion every time the sheets are stacked on the tray one by one.

According to the method, the binding processing can be done reliably in a short time without causing ununiformity of adhesive force.

Japanese Laid-open Patent Publication No. 2004-209859 suggests a method for adjusting adhesive conditions such as pressurization time, pressurization force, and heating temperature in accordance with the thickness of a sheet bundle.

The method described in Japanese Laid-open Patent Publication No. 2000-255881 has a problem in that every time a sheet is stacked, a portion corresponding to the binding margin portion is heated and pressurized, and therefore, the mechanism and the control are complicated, and frequent operation of the mechanism generates noise.

In the method described in Japanese Laid-open Patent Publication No. 2004-209859, it is inevitable that the mechanism and the control become complicated.

Even though an appropriate pressurization time can be obtained in accordance with the thickness of the sheet bundle, this does not mean that adhesive process can be done in a short time.

In view of such circumstances, there is a need to provide a sheet post-processing apparatus capable of solving the problem of complexity and noise of the mechanism and the control, and can perform binding processing in a shorter time to cope with high speed operation.

### SUMMARY OF THE INVENTION

It is an object of the present invention to at least partially solve the problems in the conventional technology.

A sheet post-processing apparatus includes: a binding unit that binds, as a bundle, a plurality of sheets by heating and pressing binding margin portions of the sheets set in advance, using toner interposed between the sheets as an adhesive material; and a pre-heating unit that heats the binding margin portions of the sheets while the sheets are stacked.

An image forming system includes: an image forming apparatus that forms an electrostatic latent image on an image carrier, makes the electrostatic latent image into a visible image as a toner image using a developing unit, transfers the toner image onto a recording medium and fixes the toner image using a fixing unit, and a sheet post-processing apparatus. The sheet post-processing apparatus includes: a binding unit that binds, as a bundle, a plurality of sheets by heating and pressing binding margin portions of the sheets set in advance, using toner interposed between the sheets as an adhesive material; and a pre-heating unit that heats the binding margin portions of the sheets while the sheets are stacked.

A sheet binding method includes: a stacking step of stacking sheets on which toner is fixed in binding margin portions; a pre-heating step of pre-heating the binding margin portions of the sheets stacked in the stacking step; a heating step of heating the binding margin portions; and an adhesive step of pressing the binding margin portions of the sheets heated in the heating step, and adhering the sheets with melted toner.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram illustrating an image forming apparatus according to a first embodiment of the present invention;

FIG. 2 is a cross sectional view illustrating a relevant portion of a sheet post-processing apparatus;

FIG. 3 is a side view illustrating a relevant portion of the sheet post-processing apparatus;

FIG. 4 is a control block diagram;

FIG. 5 is a flowchart illustrating binding processing operation;

FIG. 6 is a characteristics diagram illustrating a temperature of a sheet due to presence/absence of pre-heating;

FIG. 7 is a cross sectional view illustrating a relevant portion of a sheet post-processing apparatus according to a second embodiment;

FIG. 8 is a side view illustrating a relevant portion of the sheet post-processing apparatus;

FIG. 9 is a top view illustrating a relevant portion of the sheet post-processing apparatus;

FIG. 10 is a top view illustrating a relevant portion of the sheet post-processing apparatus when sheets are not yet stacked;

FIG. 11 is a flowchart illustrating binding processing operation according to the second embodiment;

FIG. 12 is characteristics diagram comparing relationship between adhesive force and temperature of a heat source with two types of sheets;

FIG. 13 is a figure illustrating the type of sheet;

FIG. 14 is a control block diagram of a third embodiment;

FIG. 15 is a figure illustrating detection principle and a configuration of smoothness sensor; and

FIG. 16 is a flowchart illustrating binding processing operation according to the third embodiment.

### DETAILED DESCRIPTION OF THE PREFERRED EMBODIMENTS

Hereinafter, an embodiment of the present invention will be explained in detail with reference to drawings.

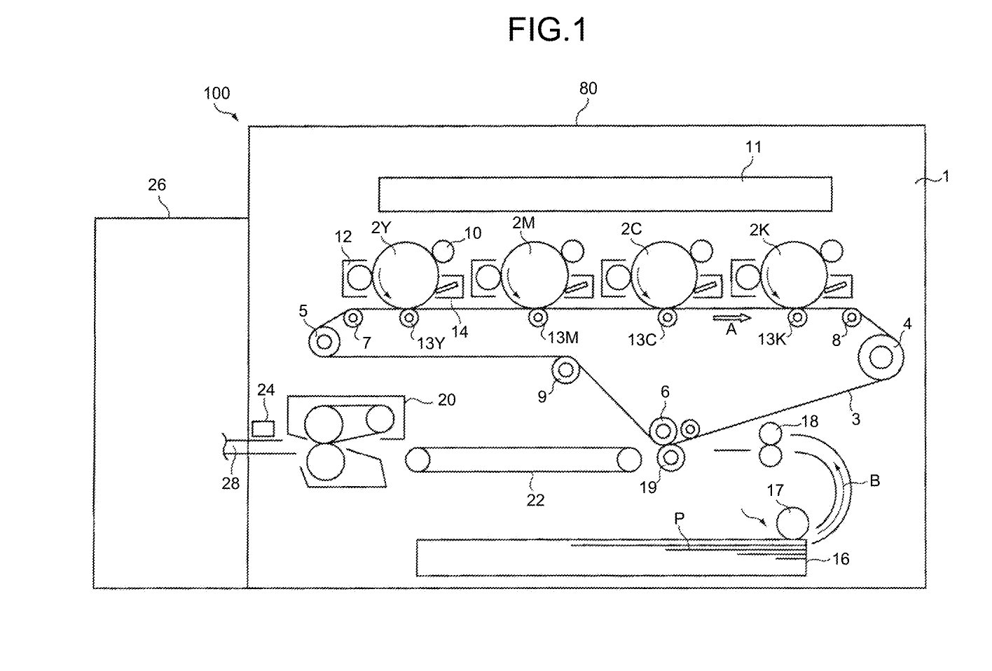

First, the first embodiment will be explained with reference to FIGS. 1 to 6.

FIG. 1 is a schematic side view illustrating an image forming system 100 according to the present embodiment.

The image forming system 100 includes an image forming apparatus 80 and a sheet post-processing apparatus (toner stapler) 26 provided at a sheet discharge side of the image forming apparatus 80.

The image forming apparatus 80 is configured as a copying machine, a printer, facsimile, or an MFP including them.

In the apparatus main body 1 of the image forming apparatus 80, image forming units are provided. The mage forming unit has multiple photosensitive drums 2Y, 2M, 2C, 2K as image carriers.

An intermediate transfer unit having an endless intermediate transfer belt 3 serving as an intermediate transfer body is provided to face a photosensitive drum of an image forming unit.

The intermediate transfer belt 3 is wound around a driving roller 4 and four driven rollers 5, 6, 7, 8.

The driving roller 4 is driven in a clockwise direction by a driving motor, not illustrated. Accordingly, the intermediate transfer belt 3 is rotationally driven in an arrow A direction.

Numeral 9 denotes a tension roller giving tension to the intermediate transfer belt 3 by being in pressurized contact with the surface of the intermediate transfer belt 3.

The photosensitive drums 2Y, 2M, 2C, 2K are rotationally driven in a counter-clockwise direction while being in contact with the surface of the intermediate transfer belt 3.

The photosensitive drum 2Y at the most upstream position in the moving direction of the intermediate transfer belt 3 is charged to a predetermined polarity by the charging roller 10, and an optically modulated laser beam emitted from the optical writing unit 11 serving as a latent image forming unit is emitted onto the charged surface.

As a result, an electrostatic latent image is formed on the photosensitive drum 2Y, and this electrostatic latent image is visualized as a yellow toner image by the developing apparatus 12 serving as the developing unit.

On the other hand, a transfer voltage is applied to the primary transfer roller 13 serving as a transfer unit by a power supply, not illustrated, and accordingly, the toner image on the photosensitive drum 2Y is primarily transferred onto the surface of the intermediate transfer belt 3 moving in an arrow A direction.

A cleaning apparatus 14 removes transfer-residual toner attached on the photosensitive drum 2Y after the toner image is transferred.

In exactly the same manner as the above process, the photosensitive drums 2M, 2C, 2K also execute image formation and transfer steps.

More specifically, a magenta toner image, a cyan toner image, and a black toner image are formed on the photosensitive drums 2M, 2C, 2K, respectively.

The toner images are successively transferred and laminated on the intermediate transfer belt 3 having the yellow toner image transferred thereon, and the toner images having four colors overlaid thereon are carried on the intermediate transfer belt 3.

At a lower portion of the apparatus main body 1, a feeding device 15 is provided.

For example, the feeding device 15 includes a sheet feeding tray 16 accommodating sheets P serving as recording media or sheets made of transfer sheets or resin films and a sheet feeding roller 17 coming into contact with the uppermost sheet P.

With the rotation of the sheet feeding roller 17, the uppermost sheet P is fed in arrow B direction.

The sheet thus fed is conveyed to a position between the intermediate transfer belt 3 and a secondary transfer roller 19 serving as a secondary transfer unit arranged to face the intermediate transfer belt 3, with predetermined operational timing by the rotation of the registration roller pair 18.

At this occasion, a transfer voltage is applied to a secondary transfer roller 19 by a power supply, not illustrated, and overlaid toner images on the intermediate transfer belt 3 are secondarily transferred onto the sheet with this operation.

The secondary transfer roller 19 is pressurized onto the driven roller 6 via the intermediate transfer belt 3, and rotates in a counter clockwise direction while being in contact with the surface of the intermediate transfer belt 3.

A sheet P is fed between the secondary transfer roller 19 and the intermediate transfer belt 3, and the overlaid toner images on the intermediate transfer belt 3 are secondarily transferred onto the sheet P.

The sheet P having the toner image transferred thereon is conveyed by the belt conveying apparatus 22 and enters into a fixing apparatus 20 serving as a fixing unit, and the toner images are fixed onto the sheet with the effect of heat and pressure.

The fixing apparatus 20 includes a heating roller 21, a fixing roller 23, and a pressing roller 25, and the sheet P having the images formed thereon is guided to a nip of the fixing roller 23 and the pressing roller 25, and the images are fixed onto the sheet P with heating and pressing.

The heating roller 21 heats the sheet P via the heating belt 27, and gives conveying force for the sheet P to the fixing roller 23.

While the sheet having finished fixing process is cooled by a cooling unit 24 such as a fan, the sheet enters into the sheet post-processing apparatus 26.

In the present embodiment, the sheet post-processing apparatus 26 is provided to be detachably attached to the apparatus main body 1 of the image forming apparatus, but may be configured integrally with the apparatus main body 1.

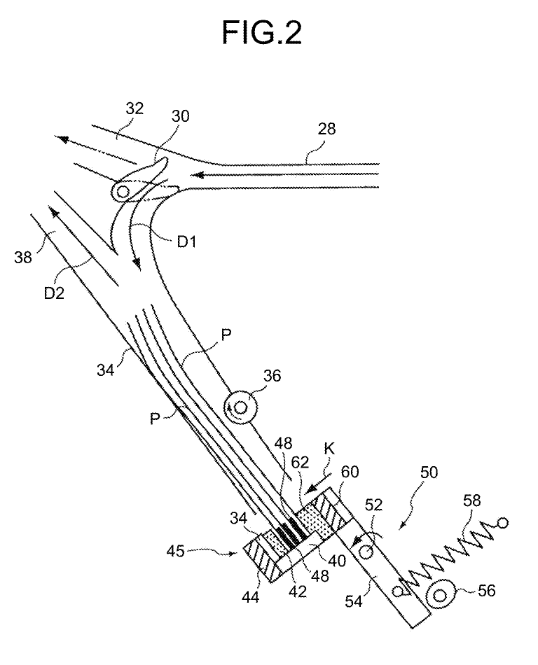

As illustrated in FIG. 2, the sheet P having entered into the sheet post-processing apparatus 26 from the apparatus main body 1 of the image forming apparatus is conveyed in a conveying path 28.

With a branching claw 30 provided downstream in the conveying direction, the conveying path for the sheet P is selectively switched between a binding processing mode and a mode for discharging the sheet without any binding processing.

In the mode without the binding processing, the branching claw 30 is set at a position indicated by a long dashed double-short dashed line, so that the sheet P is guided to a discharge path 32 and discharged onto a discharge tray, not illustrated.

In the binding processing mode, the branching claw 30 is set at a position indicated by a solid line, and the sheet P is conveyed in an arrow D1 direction and stacked on the stack tray 34 (stacking step).

After the binding processing, the sheets P are conveyed as a sheet bundle by the conveying roller 36 via the discharge path 38 in such a manner that the sheets P are switched back in an arrow D2 direction, and the sheets P are discharged to a discharge tray, not illustrated.

In the present embodiment, the sheets are configured to be discharged by the conveying roller 36, but, for example, as illustrated in FIG. 1 in Japanese Laid-open Patent Publication No. 2000-255881, a claw may be fixed to an endless belt, and the sheet may be discharged by being pushed by the claw.

The discharge path 32 and the discharge path 38 may be combined or the sheets may be discharged separately. When the sheets are discharged separately, only one discharge tray movable in the vertical direction may be shared.

At an end portion of the stack tray 34 in the discharge direction, an abutment guide 40 serving as an abutment member perpendicularly standing is formed.

The abutment guide 40 has a function of an alignment plate whereby the sheet P entering into the stack tray 34 moves obliquely downward by its own weight, and the leading end of the sheet P in the entering direction comes into abutment with the abutment guide 40 and the sheet P is aligned.

That is, the abutment guide 40 is a member for aligning the ends of the sheets close to the binding margin portions.

On the upper surface of the end portion of the stack tray 34, a rubber pad 42 is provided as a flexible member for correcting ununiformity of the pressurization force.

On the lower surface of the end portion of the stack tray 34, a receiving side heat source 44 is provided.

A pre-heating unit 45 according to the present embodiment is constructed by the end portion of the stack tray 34, the abutment guide 40, the rubber pad 42, the receiving side heat source 44, and a control unit explained later.

In this case, the “receiving side” means a side where a sheet is received when the sheet is stacked on the stack tray 34, and a side where pressurization force is received during pressing.

The pre-heating unit 45 may also be referred to as a receiving support. A configuration including the stack tray 34 and the stack tray 34 may also be referred to as a stacking unit.

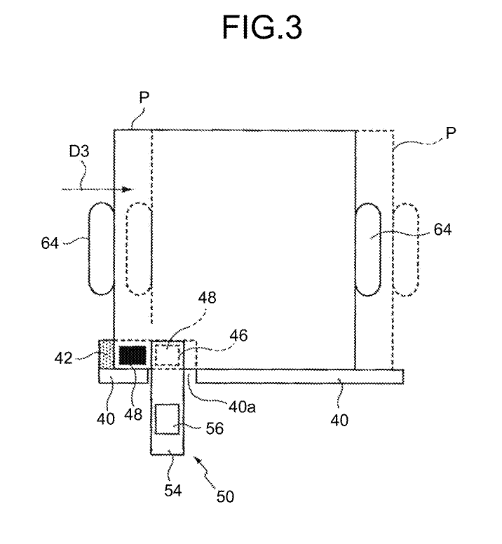

At a predetermined portion of a trailing end portion of each sheet P stacked on the stack tray 34 in a stacked state (the leading end in the entering direction), a binding margin portion 46 is provided as illustrated in FIG. 3, and a toner image 48 serving as an adhesive material is fixed to the binding margin portion 46.

The toner image 48 is toner interposed between sheets.

The binding margin portion 46 is formed in a portion other than the original image forming portion, and the toner image 48 is formed as a so-called solid image together with the original image.

The toner image 48 as well as the original image are fixed by the fixing apparatus 20.

For example, the toner image 48 serving as adhesive material (including the concept of adhesive agent) may be constructed only by one layer of black, but the adhesive force increases by constructing it from multiply layers by adding at least one of Y, M, C.

As illustrated in FIG. 2, the pressing unit 50 is provided at a portion facing the rubber pad 42 in the sheet thickness direction.

The pressing unit 50 includes a pressing lever 54 rotating around the shaft 52, an eccentric cam 56 driving the pressing lever 54 by being in contact with the end portion of the pressing lever 54, and a spring member 58 which urges the pressing lever 54 at all times so as to pivot the pressing lever 54 in a pressing direction indicated by arrow K.

At the tip of the pressing lever 54, a pressing side heat source 60 and a rubber pad 62 serving as a flexible member for correcting the ununiformity of the pressurization force are arranged in a stacked state.

The pressing lever 54 is configured to have a stroke so that the rubber pad 62 sufficiently pressing two overlaid sheets P of the minimum thickness.

As illustrated in FIG. 3, the pressing unit 50 is provided to operate in a cut-out concave portion 40a of the abutment guide 40.

The length of the abutment guide 40 is designed to be longer than the length of the sheet P in a width direction perpendicular to the conveying direction.

The cut-out concave portion 40a is provided at a position where the binding processing is performed, and has a width allowing the pressing lever 54 to perform swinging operation without interference.

In the present embodiment, the abutment guide 40 is constituted of a single board, and the cut-out concave portion 40a is provided. Alternatively, the abutment guide 40 may be constituted of two abutment guides with the operation space of the pressing lever 54 sandwiched therebetween.

After the final sheet P is stacked, a jogger fence 64 is driven in a sheet width direction (arrow D3 direction) perpendicular to the sheet bundle discharge direction, and the sheets P are adjusted (aligned) in the width direction.

The pressing unit 50 is provided so that the rubber pad 62 faces the binding margin portions 46 when aligned.

The rubber pad 42 on the receiving side has a size that can cover the displacement of the toner image 48 in association with the alignment of the jogger fence 64.

The receiving side heat source 44 is provided to be overlaid on the entire surface of the back surface of the rubber pad 42.

The pressing side heat source 60 is configured to have an area sufficient to heat the binding margin portion 46 at a position corresponding to the binding margin portion 46.

The binding processing operation (sheet binding method) using toner as adhesive material according to the present embodiment will be explained in detail.

When a command of print job accompanying the toner staple processing is given, the fixing apparatus 20 is heated to a predetermined temperature, and at the same time, the pressing side heat source 60 and the receiving side heat source 44 of the sheet post-processing apparatus 26 are also heated.

Accordingly, the pressing side rubber pad 62 is directly heated by the pressing side heat source 60, and the receiving side rubber pad 42 is heated by heat transfer via the end portion of the stack tray 34.

It should be noted that the pressing side rubber pad 62 and the receiving side rubber pad 42 are spaced apart by a distance corresponding to the sheet bundle thickness or more so as not to cause problem in sheet stack operation.

When each rubber pad reaches a predetermined temperature, a print job is started, and in addition to the original image, the toner is transferred and fixed onto the binding margin portion 46.

The sheet having the toner fixed thereon is guided to the stack tray 34 by the branching claw 30 one by one, and the sheets are stopped and retained by the abutment guide 40 and are stacked.

The receiving side rubber pad 42 and the abutment guide 40 receive heat from the receiving side heat source 44, and are controlled at a predetermined temperature (approximately 80° C.).

For this reason, when multiple sheets P are stacked (during stacked state), the binding margin portion of the sheet bundle are pre-heated from the portion of the bottom of the sheet bundle corresponding to the binding margin portion and the back portion of the sheet bundle (trailing end portion) (pre-heating step).

After the last sheet is stacked, the binding margin portion of the sheet bundle is moved to a portion close to the pressing side rubber pad 62 by the jogger fence 64 as described above.

Thereafter, the eccentric cam 56 is driven, and the pressing side rubber pad 62 heated to a predetermined temperature (approximately 180° C.) in advance is brought into pressurized contact with the binding margin portion, so that a pressure that is set in advance is applied. More specifically, the binding margin portion 46 is heated and pressed (heating step).

When it is in pressurized contact therewith for a predetermined time t (approximately five seconds), the toner of the binding margin portion is melted and the sheet bundle is adhered (adhesive step).

The eccentric cam 56 is driven to retract the pressing side rubber pad 62, and the conveying roller 36 is driven to discharge the adhered sheet bundle.

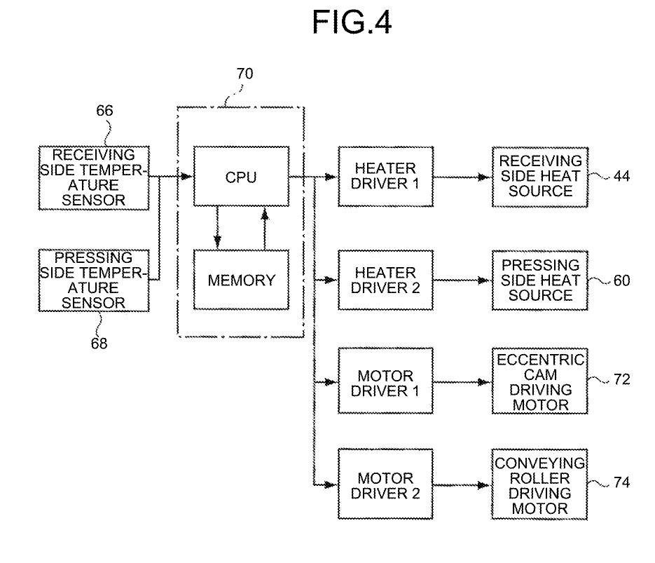

FIG. 4 is a control block diagram according to the present embodiment.

The temperature of the receiving side rubber pad 42 is detected by a receiving side temperature sensor 66, and the temperature of the pressing side rubber pad 62 is detected by a pressing side temperature sensor 68, and are input into the control unit 70.

The eccentric cam 56 is driven by an eccentric cam driving motor 72, and the conveying roller 36 is driven by the conveying roller driving motor 74.

The CPU includes a control unit and a calculation unit. The control unit interprets commands and controls flow of the control of the program. The calculation unit executes calculation.

The program is stored in a memory, and the command to be executed (a certain number of a series of numbers) is retrieved from the memory in which the program is placed, and the program is executed.

The memory also functions as a data buffer when the program is executed.

A heater driver 1 energizes the receiving side heat source 44 in response to the instruction of the CPU, and a heater driver 2 energizes the pressing side heat source 60.

The motor driver 1 drives the eccentric cam driving motor 72, and the motor driver 2 drives the conveying roller driving motor 74.

The receiving side temperature sensor 66 is provided at a predetermined position of the receiving side rubber pad 42, and the detection output is transmitted to the CPU.

As described above, the pre-heating unit 45 serving as a receiving support for the binding margin portion in the sheet post-processing apparatus 26 is constituted by the receiving side heat source 44, the abutment guide 40 that perpendicularly stands and has an L shape, and the rubber pad 42.

The pre-heating unit 45 is configured to also serve as the abutment guide 40, and therefore the heat from the receiving side heat source 44 is transmitted to not only the rubber pad 42 but also the abutment guide 40, and thus the heat can be also applied to the back portion of the sheet bundle.

A surface-like ceramic heater and the like may be used as the receiving side heat source 44 and the pressing side heat source 60, and a PID control device and the like may be used for temperature control.

The memory stores a table of temperature and time according to the sheet thickness and the number of bindings, so that the temperature and the heating time of the pressing side and receiving side rubber pads can be changed according to the sheet thickness.

Sheet thickness information is obtained from sheet thickness setting made with an operation panel or the like for a print job or by providing a sheet thickness detection sensor (sheet thickness detection unit) which is provided separately, and the table stored in the memory is looked up, and control is performed on the basis of appropriate temperature and time information.

Even when the sheet thickness setting is made, the detection information given by the sheet thickness detection sensor is used preferentially if it exists.

Therefore, even if the sheet thickness setting is false, heating temperature and time can be controlled on the basis of appropriate thickness information.

According to at least one of the factors of the thickness, the type, and the number of the sheets to be bound, at least one of the heating temperature and the pressurization time during binding process for binding the sheets may be changed.

The pressing side and receiving side rubber pads may be made of silicone rubber, and preferably have a high degree of mold releasability.

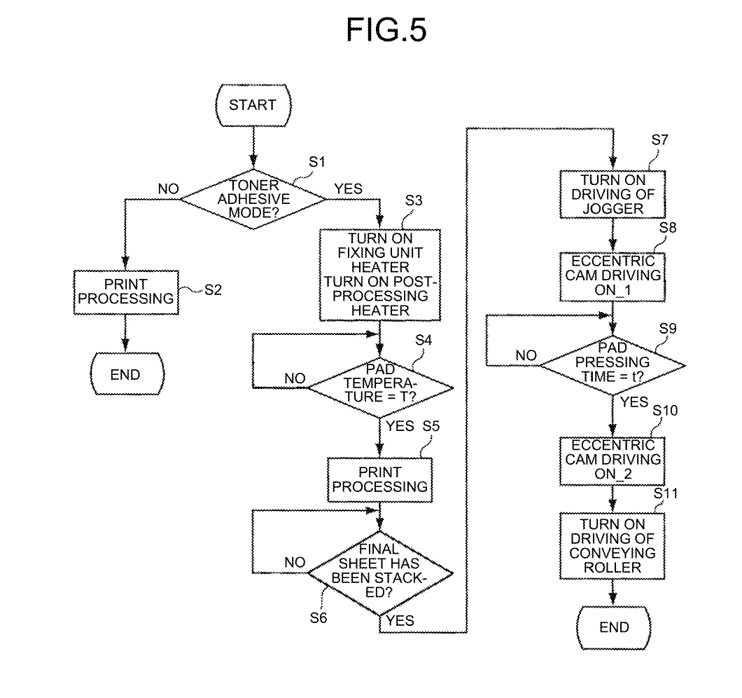

Processing operation with the image forming apparatus and the sheet post-processing apparatus 26 will be explained with reference to FIG. 5.

First, a determination is made as to whether the mode is toner adhesive mode or not (S1), and when the mode is not the toner adhesive mode, ordinary print processing is done (S2).

In this case, the sheets P for which the fixing has been made are discharged, one by one, to a discharge tray, not illustrated, via the conveying path 28 and the discharge path 32.

In the toner adhesive mode, the heater of the fixing unit (fixing apparatus) and the heater (the receiving side heat source and the pressing side heat source) of the post-processing unit (sheet post-processing apparatus) are turned on (S3).

Subsequently, a determination is made as to whether the temperatures of the receiving side rubber pad 42 and the pressing side rubber pad 62 have reached a predetermined temperature T (S4), and when they are determined to have reached the predetermined temperature T, the print processing (image forming processing) is performed (S5).

At this occasion, the pad temperature T of the pressing side rubber pad 62 is 180° C., and the pad temperature T of the receiving side rubber pad 42 is 80° C.

Subsequently, a determination is made as to whether the final sheet of a sheet bundle is stacked on the stack tray 34 (S6).

When the final sheet is stacked, a jogger motor, not illustrated, is turned on to drive the jogger fence 64 by a predetermined amount, and the binding margin portion of the sheet bundle is shifted in the sheet width direction (main scanning direction), and the binding margin portion is aligned with the position of the pressing side rubber pad 62 (S7).

The toner image 48 is not formed in the binding margin portion 46 of the sheet where the toner image 48 is in direct contact with the receiving side or pressing side.

When the alignment operation is finished with the jogger fence 64, the eccentric cam 56 is rotationally driven, and the pressing side rubber pad 62 presses the binding margin portion (S8).

Here, a pressing configuration may be employed in which the eccentric cam 56 is not in contact with the pressing lever 54.

Subsequently, a determination is made as to whether a pad pressurized contact time (pressurization time) with the rubber pad 62 reaches a predetermined time t (approximately five seconds) (S9). When it reaches the predetermined time t, the eccentric cam 56 is rotationally driven (S10), and the pressing side rubber pad 62 is separated from the binding margin portion.

Thereafter, the conveying roller 36 is rotationally driven (S11), and the sheet bundle having been subjected to the binding processing is discharged.

In the present embodiment, the rotation directions in steps S9 and S10 are in the same direction due to the shape of the cam, and are different only in the phase of rotation.

In the flowchart of FIG. 5, eccentric cam driving ON_1 in S8 corresponds to driving the pressing side rubber pad 62 in a direction for pressurized contact with the receiving side rubber pad 42.

Eccentric cam driving ON_2 in S10 corresponds to driving the pressing side rubber pad 62 in a direction for separating from the receiving side rubber pad 42. This is also applicable to the following flowchart.

Hereinafter explained is the effect of the present invention. More particularly, the difference of the adhesive time due to presence/absence of pre-heating at the end portion of the sheet in the stacked state will be explained.

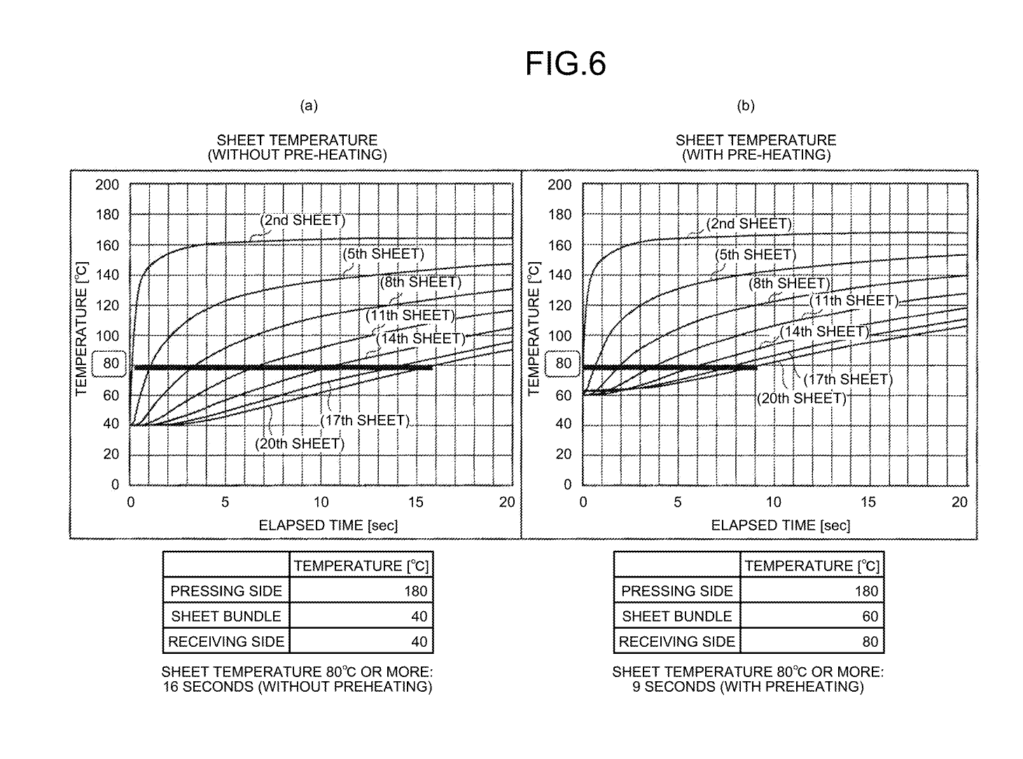

FIG. 6 is a figure for comparing adhesive time with pre-heating based on heat transfer simulation in which only one dimension (sheet thickness direction) is taken into consideration.

When there is no pre-heating, the fixed sheet is cooled to approximately 40° C. and stacked.

Accordingly, the receiving support (the end portion of the stack tray 34) after stacking is also considered to be about 40° C., and therefore, the initial temperature of the sheet bundle and receiving support is set at 40° C.

In this case, it is supposed that the sheet bundle includes about 20 sheets. FIG. 6(a) is a result obtained by calculating the sheet temperature where it is supposed that the initial temperature of the pressing side rubber pad is 180° C.

It is understood that the 20-th sheet from the pressing side where the rise of the temperature is the slowest requires a time of approximately 16 seconds to reach approximately 80° C. which is the melting point of toner.

When pre-heating is performed the fixed sheet is cooled to approximately 40° C. and stacked, but the rubber pad on the receiving support side (receiving side) is heated to 80° C.

It is supposed that the sheet bundle is at approximately 60° C. in view of the loss due to heat radiation into the air. Therefore, the sheet bundle is set at 60° C., and the initial temperature of the receiving support is set at 80° C.

FIG. 6(b) is a result obtained by calculating the sheet temperature where the initial temperature of the pressing side rubber pad is 180° C.

It is understood that the 20-th sheet from the pressing side where the rise of the temperature is the slowest requires a time of approximately nine seconds to reach approximately 80° C. which is the melting point of toner.

As compared with a case where there is no pre-heating, the adhesive time is reduced to almost half.

The actual adhesive time changes due to the pressurization force of the rubber pad and/or the like, and therefore, the actual adhesive time may be different from the calculated adhesive time, but the effect can be sufficiently confirmed.

In the embodiment, the receiving support during pressing is the end portion itself of the stack tray 34, but a receiving support may be separately provided under the receiving side heat source 44 for backup, so that the rigidness of the position during the pressing is ensured.

The receiving side configuration may be formed independently from the stack tray 34. This is applicable to the embodiments below.

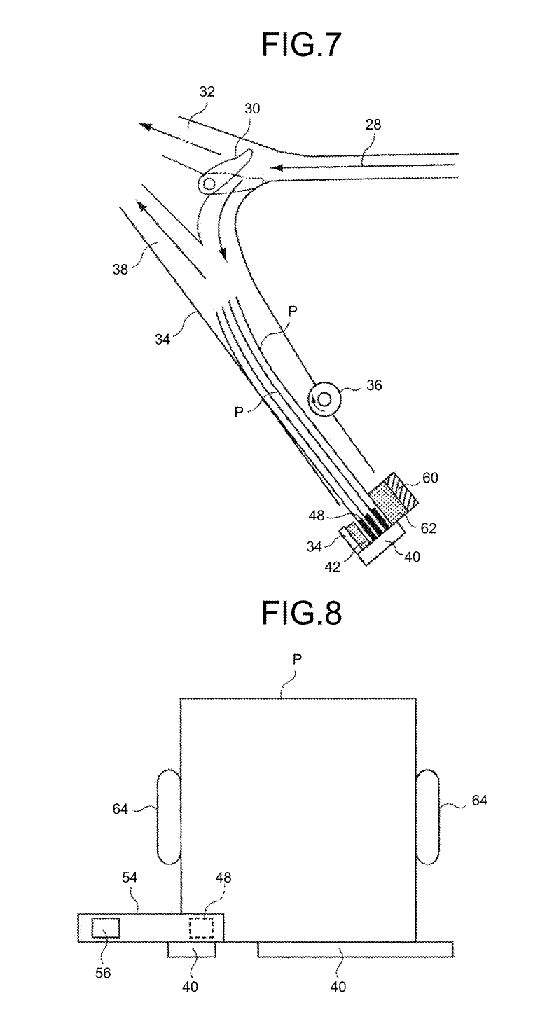

First, the second embodiment will be explained with reference to FIGS. 7 to 11.

The same portions from the above embodiment are denoted with the same numerals, and unless otherwise mentioned, explanation in terms of configuration and function which have been already explained is omitted, and only essential portion will be explained.

As illustrated in FIG. 7, the present embodiment is characterized in that the heat source is not provided in the receiving side, and the end portion of the sheet bundle in the stacked state (a portion corresponding to binding margin portions of sheets, back portion) is heated with only a pressing side heat source.

As illustrated in FIG. 8, the pressing unit 50 is arranged along the width direction of the sheet.

When a command of print job with the toner staple processing is given, the fixing apparatus is heated to a predetermined temperature, and at the same time, the pressing side heat source 60 of the sheet post-processing apparatus 26 is also heated.

In the present embodiment, before the sheets are stacked, the pressing side rubber pad 62 and the receiving side rubber pad 42 are in pressurized contact state as illustrated in FIG. 10.

The heat from the pressing side heat source 60 heats the receiving side rubber pad 42 and the abutment guide 40 via the pressing side rubber pad 62.

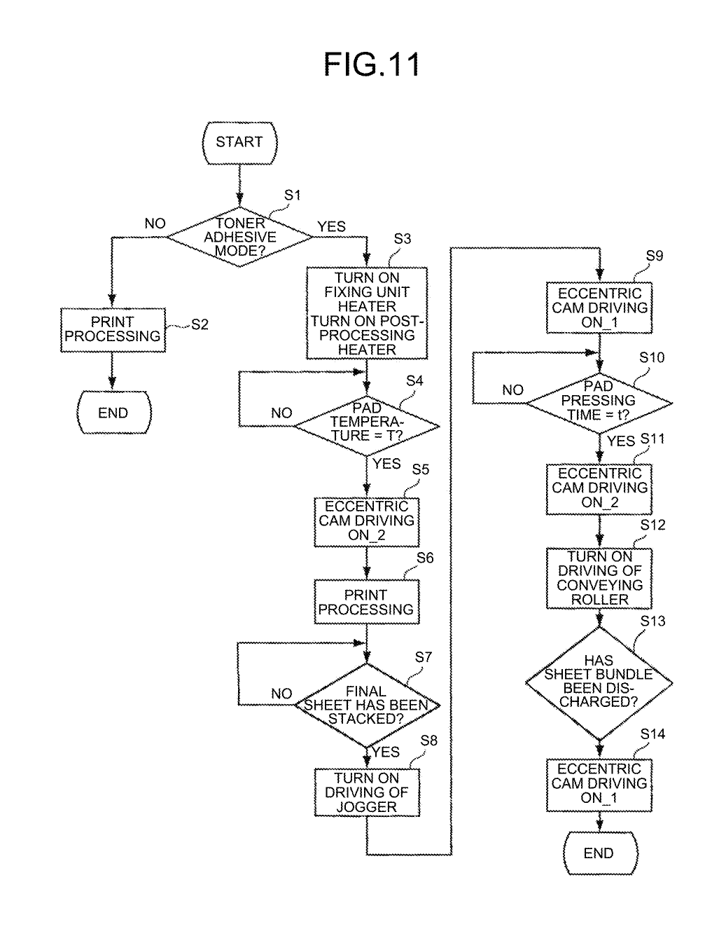

When each rubber pad reaches a predetermined temperature (FIG. 11 (S4)), the eccentric cam 56 is rotationally driven to retract the pressing side rubber pad 62.

At this occasion, the pad temperature T of the pressing side rubber pad 62 and the pad temperature T of the receiving side rubber pad 42 are 80° C.

In the present embodiment, the pre-heating unit is constituted by the receiving side rubber pad 42, the abutment guide 40, and the pressing unit 50.

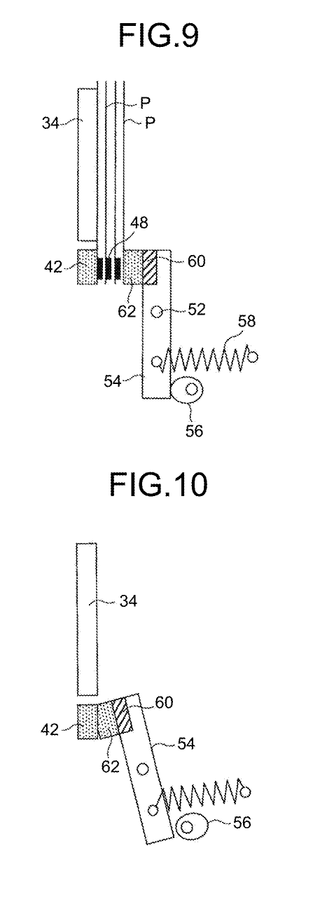

Thereafter, a print job is started, and as illustrated in FIG. 9, the fixed sheets are stacked on the stack tray 34 one by one.

The receiving side rubber pad 42 and the abutment guide 40 are pre-heated as described above.

For this reason, the binding margin portion of the sheet bundle in the stacked state is heated by accumulated heat of the rubber pad 42 and the like from the back portion of the sheet bundle and the portion under the sheet bundle and corresponding to the binding margin portion.

The abutment guide 40 may be made of rubber like the rubber pad 42.

After the final sheet is stacked, jogger processing is performed, and then the eccentric cam is driven (FIG. 11 (S9)), and the pressing side rubber pad 62 heated to a predetermined temperature (approximately 180° C.) in advance is brought into pressurized contact with the binding margin portion.

The eccentric cam 56 in S9 of FIG. 11 is rotationally driven to a position where the eccentric cam 56 is no longer in contact with the pressing lever 54.

With the urging force of the spring member 58, the pressing side rubber pad 62 is brought into pressurized contact with the binding margin portion of the sheet bundle.

When there is no sheet bundle, the rubber pad 62 is in pressurized contact with the receiving side rubber pad 42 as illustrated in FIG. 10.

When it is in pressurized contact therewith for a predetermined time t (approximately five seconds), the toner of the binding margin portion is melted and the sheet bundle is adhered.

Thereafter, the eccentric cam is driven to retract the pressing side rubber pad 62, and the conveying roller 36 is driven to discharge the sheet bundle adhered.

Thereafter, the eccentric cam 56 is driven again, and the apparatus waits while the pressing side rubber pad 62 is in pressurized contact with the receiving side rubber pad 42 (FIG. 11 (S14)).

FIG. 11 is a flowchart illustrating processing procedure of toner adhesive processing executed by the CPU of the present embodiment.

In this flowchart, in addition to the processing procedure as illustrated in FIG. 5 of the first embodiment, processing of step S5 is added after step S4, and processing of steps S13 and S14 is added after step S11.

The processing of step S5 is processing for driving the eccentric cam 56 to separate the pressing side rubber pad 62 from the receiving side rubber pad 42.

This processing is processing for receiving sheet P from the image forming apparatus after the rubber pad 42 is given heat by the rubber pad 62.

The processing of S13 is processing for confirming the completion of discharge of sheet bundle, and corresponds to processing in preparation stage of the processing of S4.

More specifically, after it is confirmed that the sheet bundle is discharged from the stack tray 34, the eccentric cam 56 is driven to bring the pressing side rubber pad 62 into contact with or pressurized contact with the receiving side rubber pad 42 in S14.

Accordingly, during the standby state without the toner adhesive processing, the receiving side rubber pad 42 is heated by the pressing side rubber pad 62, and the heat can be accumulated. Other processing is the same as the first embodiment.

According to the present embodiment, the heat source for binding the sheets as a bundle and the heat source serving as the pre-heating unit are shared, and therefore, it is not necessary to separately provide a heat source for pre-heating. Accordingly, the necessity of a heat source for pre-heating is eliminated, and this can reduce the increase of the cost.

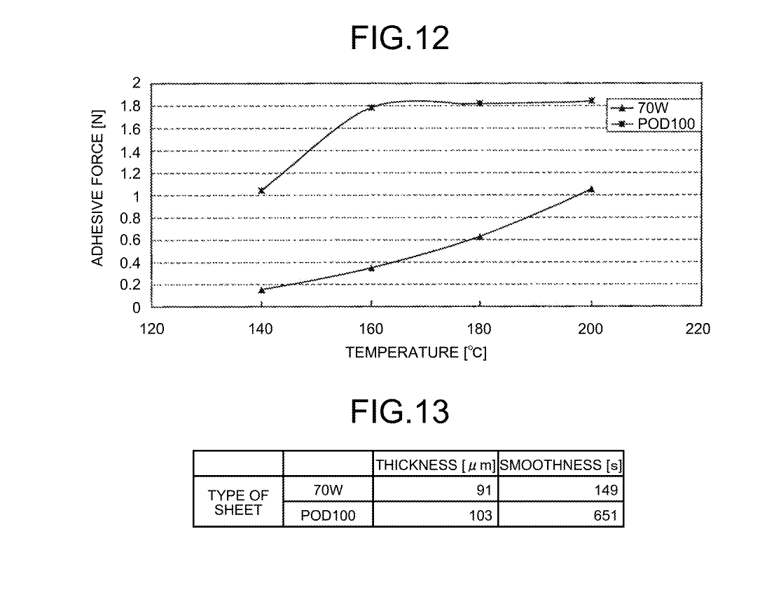

The third embodiment will be explained with reference to FIGS. 12 to 16.

In the toner adhesive processing of each of the above embodiments, the type of sheet is not taken into consideration. The present embodiment is an example for performing toner adhering operation in view of the type of sheet.

FIG. 12 is characteristics diagram comparing relationship between adhesive force and temperature of a heat source with two types of sheets as illustrated in FIG. 13.

The horizontal axis denotes a temperature [° C.], and a vertical axis denotes an adhesive force [N]. In the present embodiment, in order to find basic adhesive performance, characteristics test is done under a condition of one-second heating with two sheets adhered.

70W illustrated in FIG. 13 is generally classified as an ordinary sheet, and a POD 100 is classified as a coated sheet.

As illustrated in FIG. 12, although the thicknesses are substantially the same, the adhesive force with respect to the temperature of the heat source is greatly different.

This is because their degrees of smoothness are different. The lower the smoothness is, the lower the adhesive force is.

The reason why the adhesive force is weaker due to lower degree of smoothness is that a toner layer interposed between the sheets as the adhesive layer becomes thinner and air layer exists between sheets, and heat conductivity to the toner is considered to decrease.

As described above, the adhesive force is greatly different depending on the smoothness, and therefore, it is desired to set the temperature of the heat source in accordance with the smoothness.

For example, when a desired adhesive force is 1 [N], 70W requires approximately a heat source temperature of 200° C., but POD 100 requires about only 140° C.

From the above result of experiment, in the control circuit of the first embodiment illustrated in FIG. 4, it is desired to hold, as a table, the temperature of the heat source depending on the smoothness of the sheet.

More specifically, the relationship between the type of the sheet (smoothness) and the temperature of the heat source is made into a table and held in the memory, so that information about the sheet type selected by the print job is collated in the memory, and the temperature of the heat source can be selected appropriately.

By doing so, an appropriate amount of heat for achieving desired adhesive force can be given to the sheet in accordance with the type of the sheet (smoothness), and while the adhesive force is maintained, power-saving performance can be improved.

Instead of allowing the user to set a print job, the smoothness of the sheet is detected separately, and the temperature of the heat source can be set appropriately on the basis of the detection signal thereof.

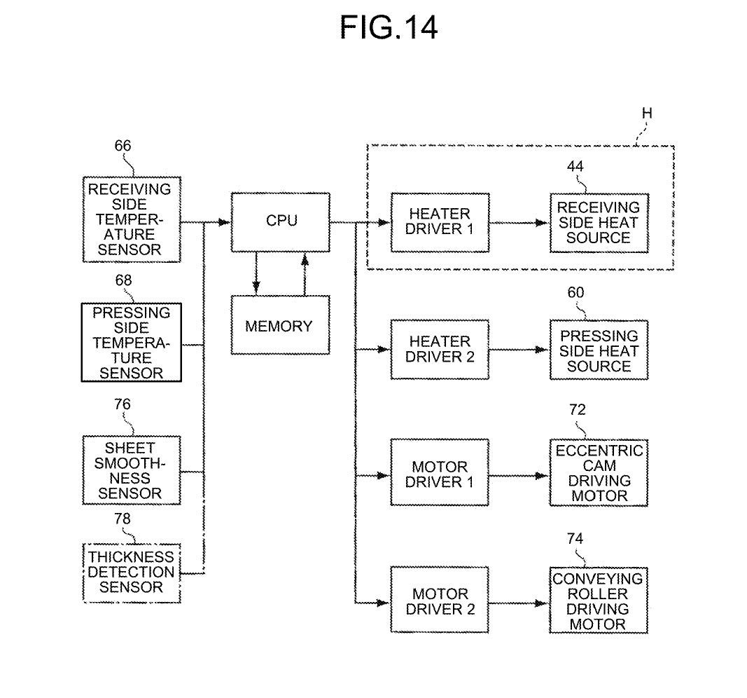

FIG. 14 is a block diagram illustrating a control configuration of binding processing performed by the sheet post-processing apparatus 26 according to the present embodiment.

In the present embodiment, the smoothness of the sheet is detected, and the heating control is performed. In the block diagram as illustrated in FIG. 14, the control configuration illustrated in FIG. 4 additionally includes a sensor for detecting the type of the sheet. In this case, it additionally includes a sheet smoothness sensor for detecting the smoothness of the sheet (hereinafter simply referred to as “smoothness sensor”) 76.

The sensor output of the smoothness sensor 76 is configured to be input into the CPU.

The CPU performs pre-heating control by referring to a table stored in a memory as described above on the basis of a sensor output which is given by the smoothness sensor 76, and executes the toner adhesive processing on the sheet bundle.

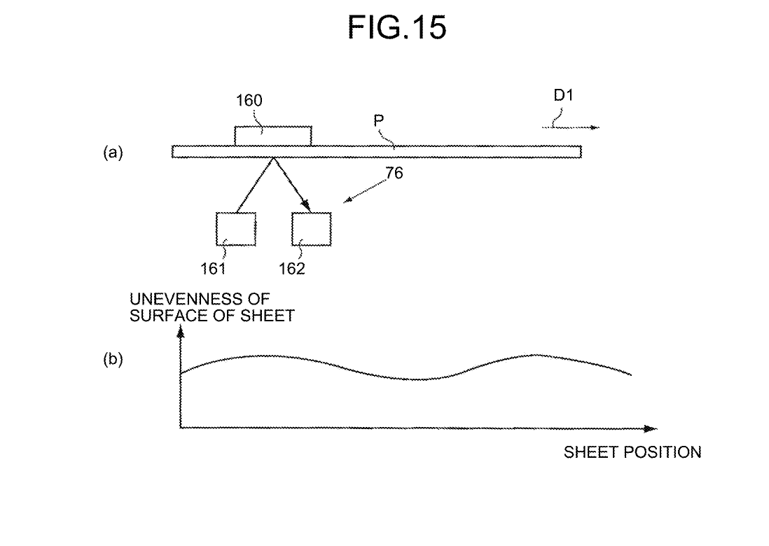

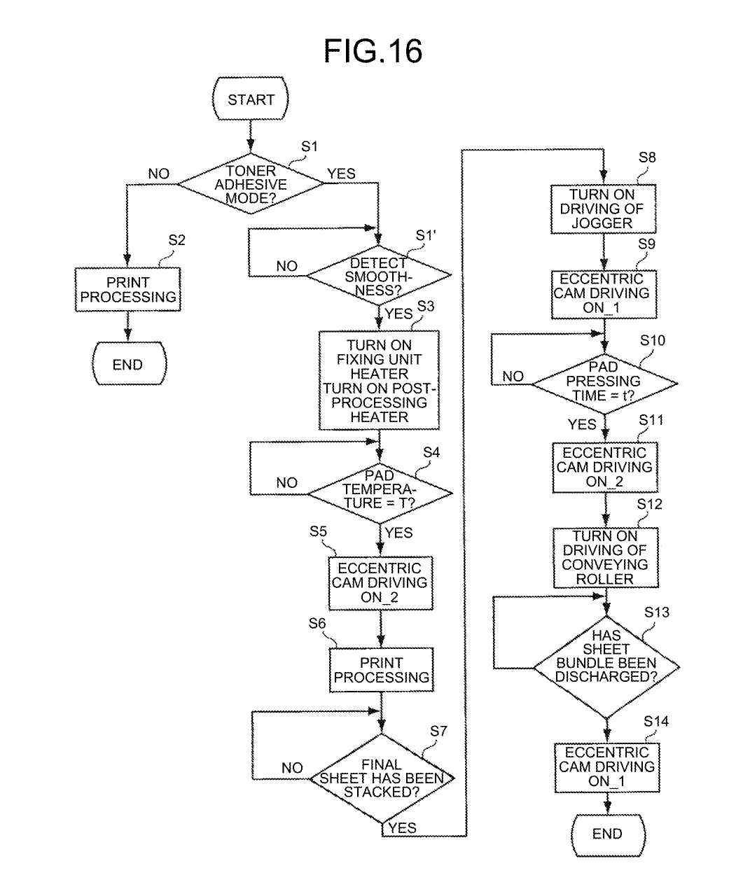

FIG. 15 is a figure illustrating principle of detection and configuration of the smoothness sensor 76. FIG. 16 is a flowchart illustrating processing procedure when the toner adhesive processing is performed using the smoothness sensor 76 in the second embodiment.

It should be noted that, when the smoothness sensor 76 is applied in the second embodiment, a configuration of H corresponding to the receiving side heat source 44 of the first embodiment in the block diagram of FIG. 14 is not provided.

In this configuration, the processing illustrated in FIG. 16 is executed.

The smoothness sensor 76 is a sensor for measuring the smoothness of the sheet surface conveyed along the sheet conveying path.

As illustrated in FIG. 15(a), the smoothness sensor 76 includes a light source 161 for emitting light onto the sheet P and a photodiode 162 for detecting light reflected by the sheet P or a reference plate 160.

The laser light incident upon the photodiode 162 (reflected light) changes in accordance with unevenness of the sheet surface and the thickness of the sheet P.

The smoothness sensor 76 generates a signal indicating the thickness and unevenness of the sheet on the basis of this change, and outputs the signal to the CPU.

FIG. 15(b) is a figure schematically illustrating relationship of unevenness of the sheet and the sheet position.

On the other hand, data representing the relationship between the heat source temperature and the signal indicating unevenness are made into a table and stored in advance into the memory.

Accordingly, the CPU compares and refers to the data stored in the table of the memory and the output as illustrated in FIG. 15(b) of the smoothness sensor 76, and thereby, the temperature of the heat source is appropriately selected in accordance with the thickness of the sheet P.

The processing procedure illustrated in the flowchart of FIG. 16 is obtained by providing smoothness detection determination procedure S1′ after step S1 in the flowchart of the second embodiment as illustrated in FIG. 11.

More specifically, when the mode is determined to be the toner adhesive mode in S1, first, a determination is made as to whether a detection output is input from the smoothness sensor 76 or not.

After the detection output is input from the smoothness sensor 76, processing of S3 and subsequent steps are executed. At that occasion, the pad temperature in S4 is set at the appropriate temperature of the heat source according to the smoothness of the sheet P selected as described above, and the subsequent processing is executed in the same manner as the second embodiment.

As described above, when the temperature of the heat source is controlled using the detection output of the smoothness sensor 76, an appropriate amount of heat can be given to the sheet so as to achieve desired adhesive force according to the type of sheet even when the user makes mistake in setting the type of sheet.

Accordingly, while the adhesive force with the toner between sheets of the sheet bundle is maintained, power-saving performance can be improved.

Instead of the smoothness sensor 76 or in addition to the smoothness sensor 76, a thickness detection sensor 78 may be provided to detect the sheet thickness in the sheet conveying path as illustrated by an alternate long and short dash line in FIG. 14.

In this case, in S1′ of FIG. 16, the sheet thickness is determined on the basis of the detection data given by the thickness detection sensor 78, and the amount of heat added is set from the sheet thickness determined, and the subsequent processing is executed.

At this occasion, like the smoothness detected by the smoothness sensor 76, the temperature of the heat source according to the thickness of the sheet is held as the table, and the table is used.

According to the present embodiment, the amount of heat applied to the binding margin portion from the heat source is controlled on the basis of one of the thickness of the sheet P, the number of sheets bound, and the smoothness, and therefore, even when the sheet thickness, the number of sheets, and the smoothness are different for each print job, the amount of heat can be given appropriately to the binding margin portion.

As a result, power-saving performance can be improved.

The higher the smoothness is, the lower the amount of heat applied is set, and therefore, while the adhesive force is maintained, power-saving performance can be improved.

An appropriate amount of heat can be given to the binding margin portion in accordance with the smoothness of the sheet P obtained from the smoothness sensor even when the user makes mistake in setting the type of sheet.

An appropriate amount of heat can be given to the binding margin portion in accordance with the thickness information about the sheet P obtained from the sheet thickness detection sensor even when the user makes mistake in setting the sheet thickness.

In each of the above embodiments, the lower side in the sheet thickness direction is defined as a receiving side, and an upper side thereof is defined as the pressing side, but this may be defined oppositely.

According to the embodiment, the problem of complexity and noise of the mechanism and the control can be solved, and binding processing using toner as an adhesive material can be done in a shorter time to cope with high speed operation.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A sheet post-processing apparatus comprising:
a binding unit that binds, as a bundle, a plurality of sheets by heating and pressing binding margin portions of the sheets set in advance, using toner interposed between the sheets as an adhesive material; and
a pre-heating unit that heats the binding margin portions of the sheets while the sheets are stacked.

2. The sheet post-processing apparatus according to claim 1, comprising an abutment member to align ends of the sheets closer to the binding margin portions,
wherein the pre-heating unit also serves as the abutment member.

3. The sheet post-processing apparatus according to claim 1, wherein the pre-heating unit is provided on at least one of a side where the sheets are received when the sheets are stacked and a side where the sheets are pressed when the sheets are bound as the bundle.

4. The sheet post-processing apparatus according to claim 1, wherein a heat source to bind the sheets as the bundle and a heat source of the pre-heating unit are same.

5. The sheet post-processing apparatus according to claim 1, wherein an amount of heat to bind the sheets as the bundle is changed according to any one of factors including thickness of the sheets, a type of the sheets, and number of the sheets to be bound.

6. The sheet post-processing apparatus according to claim 5, comprising a smoothness detection unit that detects smoothness of the sheets, wherein the amount of heat is changed according to smoothness.

7. The sheet post-processing apparatus according to claim 6, wherein the higher the smoothness is, the lower the amount of heat is set to be.

8. The sheet post-processing apparatus according to claim 5, comprising a sheet thickness detection unit that detects thickness of the sheets,
wherein even when the thickness of the sheets is input, detection information provided by the sheet thickness detection unit is used preferentially.

9. An image forming system comprising:
an image forming apparatus that forms an electrostatic latent image on an image carrier, makes the electrostatic latent image into a visible image as a toner image using a developing unit, transfers the toner image onto a recording medium and fixes the toner image using a fixing unit, and
a sheet post-processing apparatus, wherein
the sheet post-processing apparatus comprises:
a binding unit that binds, as a bundle, a plurality of sheets by heating and pressing binding margin portions of the sheets set in advance, using toner interposed between the sheets as an adhesive material; and
a pre-heating unit that heats the binding margin portions of the sheets while the sheets are stacked.

10. A sheet binding method comprising:
a stacking step of stacking sheets on which toner is fixed in binding margin portions;
a pre-heating step of pre-heating the binding margin portions of the sheets stacked in the stacking step;
a heating step of heating the binding margin portions; and
an adhesive step of pressing the binding margin portions of the sheets heated in the heating step, and adhering the sheets with melted toner.
